(19) United States
(12) Patent Application Publication
(10) Pub. No.: US 2012/0166874 A1
(43) Pub. Date: Jun. 28, 2012

(54) Wireless Device Expert System

(76) Inventors: Timothy Bernardez, Cumming, GA (US); Rodney White, Dripping Springs, TX (US); Phil Bramson, Arlington, VA (US); Jianxue Wu, Leesburg, VA (US); Amarnath Guddeti, Leesburg, VA (US)

(21) Appl. No.: 12/978,937

(22) Filed: Dec. 27, 2010

Related U.S. Application Data
(60) Provisional application No. 61/426,516, filed on Dec. 23, 2010.

(51) Int. Cl. G06F 11/07

(52) U.S. Cl. 714/26; 714/E11.029

(57) ABSTRACT

A wireless expert system connects to a plurality of diagnostic modules and is configured to receive a complaint from a user of a wireless device, the complaint comprising data and attributes. The expert system executes a two-phase process. In the first phase, the complaint is analyzed to determine which of the diagnostic modules should be run. In the second phase, the selected diagnostic modules are run, and the user is provided with a recommended corrective action. If the action is successful, the expert system is updated with the successful resolution, providing additional assurance for future analyses.

### CROSS REFERENCE TO RELATED APPLICATIONS

This application claims priority to U.S. Provisional Application 61/426,516, filed Dec. 23, 2010, entitled “Wireless Device Expert System,” which is incorporated herein by reference.

### BACKGROUND

This specification relates to the field of mobile computing, and more particularly to an expert system for troubleshooting of wireless communication devices.

Wireless handheld devices have become increasingly popular for business, gaming, reading, and communication. Wireless devices may sometimes experience problems from hardware or software errors, which can impair their utility.

### BRIEF DESCRIPTION OF THE DRAWINGS

FIG. 1 is a network diagram of an exemplary commercial network containing a diagnostic system, which provides a wireless expert system.

FIG. 2 is a functional block diagram of an exemplary diagnostic system.

FIGS. 3 and 3A provide a functional block diagram of a wireless device expert system.

FIG. 4 provides a block diagram of a hardware diagnostic module.

FIG. 5 provides a block diagram of a third-party application diagnostic module.

FIG. 6 provides a block diagram of a wireless network diagnostic module.

FIG. 7 provides a block diagram of a firmware compliance module.

FIG. 8 provides a block diagram of a data repository.

FIG. 9 provides a block diagram of an input/output module.

FIGS. 10-10C provide a flow chart of an exemplary high-level retail process for using a wireless device expert system to analyze a wireless device.

FIG. 11 provides a flow chart of an exemplary process for a wireless device expert system identifying potential hardware, firmware, and third-party application issues.

### SUMMARY OF THE INVENTION

In one aspect, a wireless expert system connects to a plurality of diagnostic modules and is configured to receive a complaint from a user of a wireless device, the complaint comprising data and attributes. The expert system executes a two-phase process. In the first phase, the complaint is analyzed to determine which of the diagnostic modules should be run. In the second phase, the selected diagnostic modules are run, and the user is provided with a recommended corrective action. If the action is successful, the expert system is updated with the successful resolution, providing additional assurance for future analyses.

### DETAILED DESCRIPTION OF THE EMBODIMENTS

An exemplary wireless expert system is disclosed herein that is configured to receive a complaint related to a wireless device and to intelligently provide a recommended resolution action. The system and method disclosed is described as a wireless expert system by way of example only. The system and method is suitable and adaptable to be used more generally for other types of systems experiencing faults, including but not limited to gaming devices; computers and laptops; consumer electronics such as televisions, radios, and personal media players; cameras and camcorders; telemetry devices; all types of wireless communication devices; electromechanical systems including automobiles and aircraft; heating and air conditioning systems; and home appliances.

A wireless device expert system is configured to intelligently resolve hardware and software issues arising in consumer wireless devices. In the exemplary embodiment, the wireless device expert system is a computing device configured to communicatively coupled with a plurality of diagnostic modules. Each of the diagnostic modules has a designated function, and is configured to provide to the expert system an analysis of a particular subsystem of the wireless device. The expert system is configured to receive from a user a complaint, the complaint comprising data and attributes. The data may include fault data or other raw analytical data. The attributes may include, for example, hardware characteristics, operating system version, firmware version, firmware checksum, installed applications, and other key operating data, as well as metadata describing the types of data provided. Based on the complaint, the expert system may intelligently decide which modules to query. For example, the expert system may have a data repository, which is a database configured to contain data necessary for providing an expert system, and may be based on historical resolutions. Based on its query of the data repository, the expert system will query only those modules identified as appropriate. The expert system then ranks propose solutions according to the most likely to fix the problem. In one exemplary method, the expert system provides the user with the most likely proposed resolution, and then receives feedback from the user indicating whether the proposed solution fixed the error. If the proposed solution did not work, then the expert system provides them the next most likely resolution. The expert system then iteratively provides each of the proposed solutions, until it locates the successful solution. The feedback from the user is integrated into the expert system's data repository to provide additional information for future analyses.

An exemplary complaint may indicate that the user has encountered excessive dropped calls. Upon receiving the complaint, the expert system will query its database to determine which modules are needed to resolve the dropped calls complaint. The expert system may determine that third-party applications and firmware are not likely to be the cause of dropped calls, but that wireless network problems or hardware problems may be the source of dropped calls. The expert system then provides the complaint data to the wireless network diagnostic module and the hardware diagnostic module. These modules also query databases to determine, based on the attributes provided in the complaint, which causes most strongly correlate to the complaint. These correlations will in some cases be based on historical resolutions of similar problems. The diagnostic modules provide back to the expert system proposed resolutions, which are ranked according to those most likely to resolve the issue. The expert system then provides the resolutions to the user.

To further enhance the utility of a wireless device expert system, a Decision Science Team (DST) may also be used to evaluate difficult problems. For example, the DST may include a number of subject matter experts who are skilled in resolving wireless device issues. The subject matter experts may receive the complaint, including the date and attributes, and based on the complaint, assist the expert system in determining which diagnostic modules need to be queried. The decision science team may also assist diagnostic modules in identifying potential solutions, and in ranking the probability of solutions fixing the problem. Because the accuracy of the expert system increases with iterative use, the decision science team will be more important when the database is new, and less important as the database matures and defines increasingly strong correlations between problems and resolutions.

In some embodiments, the expert system and modules may communicate with each other by passing XML or other structured text. In one exemplary embodiments, all requests include a Transaction ID, which will be sent back with proposed resolutions so that the requesting system can correctly associate the response. Other commonly useful fields are also provided, such as <Header> and <Error>. If there is an error while processing the request the error number and error message is passed back in the <Error> field. If there is no error then the <Error> node would still be present but the error number and error message elements would be empty.

Exemplary diagnostic modules include a hardware diagnostic module, a third-party application diagnostic module, a wireless network diagnostic module, and a firmware compliance diagnostic module. The DST may also be considered a diagnostic module in some cases. Some or all of the diagnostic modules may be internal modules to the expert system (for example, provided as software modules), external functionality provided by external systems, or a combination of both.

By way of example, a wireless device expert system may provide diagnostics of problems such as third-party software issues and dropped calls. The following tables describe exemplary capabilities with respect to those issues respectively.

TABLE 1
Third-Party Application Services
Third-Party Applications

| (1) | Provide the ability to access and read Third Party application on a | |
|---|---|---|
| | device based on complaint types. | |
| (2) | Provide the ability to read Third Party Applications on a device | |
| (3) | Prompt the user to access device to determine corrupt applications | |
| (4) | Notify the user that the expert system is ‘accessing the device’ | |
| (5) | Provide the ability to flag a single Third Party Application as ‘corrupt’ | |
| | for a particular model through the admin module | |
| | (5a) | Provide the ability to flag at the software version level |
| | (5b) | Provide the ability to flag a combination of applications as |
| | | ‘corrupt’ where only the combination of applications is invalid. |
| | (5c) | Provide the ability to flag an application or combination of |
| | | applications as ‘corrupt’ for all devices. |
| (6) | Display to the user the ‘corrupt’ application or combination of | |
| | applications | |
| (7) | Provide the ability to automatically remove the application(s) if the | |
| | users selects to do so | |
| (8) | Provide the ability to store Third Party application identified by expert | |
| | system with the ticket. | |
| | (8a) | Store version number if available |

TABLE 2
Dropped Call Services
Dropped Calls

| (1) | Provide the ability to automatically call a network tool based on complaint types | | |
|---|---|---|---|
| (2) | Prompt the user to proceed to the ‘Network Tool’ | | |
| (3) | Notify the user that expert system is ‘checking device performance on the network’. | | |
| (4) | Provide the ability to validate percentage of dropped calls on the carriers network over a | | |
| | configurable period of time | | |
| | | a. | The location referenced should be that of the most recent locations based on the |
| | | | configurable period of time. |

| | |
|---|---|
| (5) | Provide the ability to recommend a solution based on the % of dropped calls and the device |
| | model. |
| (6) | Provide the ability to display the network statistics and the recommended expert system |
| | solution screen |
| (7) | The recommended solutions will not include recommendations from the Knowledge |
| | Database |

Additional useful functions may also include:

TABLE 3
Expert System Functions

| 1. | Troubleshooting |
|---|---|
| 1.1. | Provide the ability to automatically diagnose a device and provide a recommendation |
| 1.2. | Provide the ability to capture whether the suggested solution resolved the issue. |
| 1.3. | Provide the ability to recommend another solution if the prior solution did not resolve |
| the issue. | |
| 1.4. | Provide the ability to identify if the issue is network or device related. |
| 1.5. | Provide APIs for Third Party ticketing systems to access the troubleshooting software |
| 1.6. | Provide the ability to determine device performance on network |
| 1.7. | Provide the ability to determine network/tower performance in the area |
| 1.8. | Provide the ability to determine possible hardware failures based on device |
| performance | |
| 1.9. | Provide the ability to determine possible device software issues. |
| 1.10. | Provide the ability to determine if there are manufacturer warranties associated to |
| the device. | |
| 1.11. | Provide the ability to determine whether the issue can be resolved by accessing |
| internal database or whether to initiate call to Third Party Applications | |
| 1.12. | Provide the ability to compile data from inetrnal database and various Third Party |
| applications within 20 seconds. | |
| 2. | Admin Module/Reporting |
| 2.1. | Provide the ability to weigh recommended solutions based on data entered from the |
| Decision Science team analysis | |
| 2.2. | Provide the ability to enter recommended solutions and custom messages |
| 2.3. | Provide reports that analyze complaints, resolution, and success rate |
| 3. | Device Reader |
| 3.1. | Provide the ability to tether to a device and read device model |
| 3.2. | Provide the ability to tether to a device and read and store loaded Third Party |

| Applications | |
|---|---|
| 3.3. | Provide the ability to tether to a device and read and store device settings includes |

| security settings | |
|---|---|
| 3.4. | Provide the ability to i tether to a device and dentify and store applications in process |
| 3.5. | Provide the ability to tether to a device and read and store free and used memory |
| 3.6. | Provide the ability to tether to a device and read and store device operating software |
| and version | |
| 3.7. | Provide the ability to tether to a device and read and store PRL |
| 3.8. | Provide the ability to tether to a device and read and store error messages |
| 4. | Content Back Up |
| 4.1. | Provide the ability to store device phone book, calendar, notes, and downloaded |
| items. | |
| 4.2. | Provide the ability to access and restore information to another device |
| 4.3. | Provide security controls for accessing device stored device information |
| 4.4. | Provide the ability to access and restore information to another device via the web |
| 5. | Third Party Applications |
| 5.1. | Provide the ability to access in real-time Third Party software that provides |
| network/tower performance | |
| 5.2. | Provide the ability to access in real-time Third Party software that provides model |
| diagnostics | |
| 5.3. | Provide the ability to access in real-time Third Party software that provides device |
| performance on the network | |
| 5.4. | Provide the ability to access in real-time Third Party software that provides |
| manufacturer warranty issues. | |
| 5.5. | Provide the ability to access in real-time Third Party software that provides software |
| diagnostics. | |
| 6. | Ticketing System |
| 6.1. | Provide the ability to capture customer information |
| 6.2. | Provide the ability to capture a unique transaction ID, PTN, model, device |
| information, complaint, recommended solutions, solution's success for each transaction. | |
| 6.3. | Provide the ability to interface with the Troubleshooting system and display |
| responses and capture success/failure. | |
| 6.4. | Provide the ability to print a transaction summary that provides status on all items |
| checked by the Troubleshooting Software | |
| 6.5. | Provide the ability to automatically calculate charges based on complaint and work |
| performed. | |
| 6.6. | Provide the ability to process a swap if device replacement is recommended |
| 6.7. | Provide the ability to place an order for an exchange device |

Provide the ability to receive and ordered device and capture customer pick up

A wireless device expert system will now be described with more particular reference to the attached drawings. Hereafter, details are set forth by way of example to facilitate discussion of the disclosed subject matter. It should be apparent to a person of ordinary skill in the field, however, that the disclosed embodiments are exemplary and not exhaustive of all possible embodiments. Throughout this disclosure, a hyphenated form of a reference numeral refers to a specific instance or example of an element and the un-hyphenated form of the reference numeral refers to the element generically or collectively. Thus, for example, 102-1 may refer to a “pen,” which may be an instance or example of the class of “writing implements.” Writing implements may be referred to collectively as “writing implements 102” and any one may be referred to generically as a “writing implement 102.”

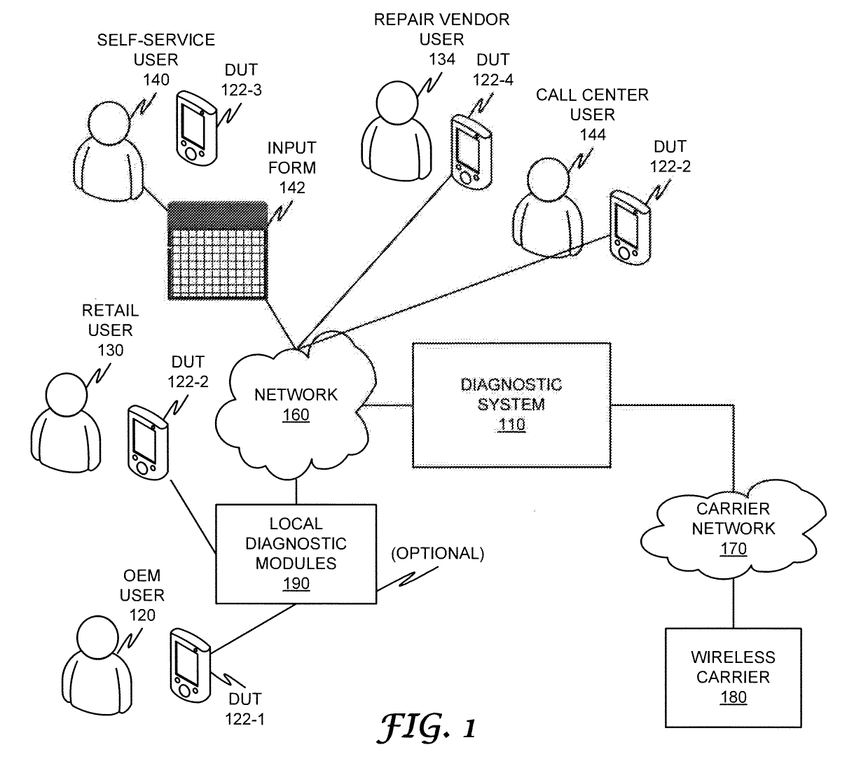

FIG. 1 is a network level block diagram of a commercial system for use with a wireless device expert system. Diagnostic system 110 connects to a network 160, which may be the Internet or a similar peer-to-peer network configured to enable communication between diverse devices. Network 116 provides interconnectivity with several users of diagnostic system 110. For example, an OEM user 120 may have a diagnostic device under test 122-1, which may be a cell phone, smartphone, or other similar wireless communication device. While DUT 122 is disclosed as a wireless device, the system and method of the present disclosure are suitable for

OEM user 120 intends to test DUT 122-1, and may optionally connect to local diagnostic modules 190. Local diagnostic modules 190 connect via network 160 to diagnostic system 110. Local diagnostic modules 190 are shown by way of example only, to demonstrate the potentially distributed nature of diagnostic modules, which may physically be located at almost any point in the system.

Similarly, retail user 130 may have DUT 122-2, which also connects to local diagnostic modules 190. Also shown is self-service user 140, owning DUT 122-3. In the exemplary embodiment, self-service user 140 does not have any local diagnostic modules, and instead communicates with diagnostic system 110 strictly via input form 142. Input form 142 may be a web-based interface, and may allow self-service user 142 to answer questions about the malfunction that he is experiencing with DUT 122-3, and to receive recommended resolution. Other exemplary users may include a repair vendor user 134, and a call center user 144.

Diagnostic system 110 may also connect via carrier network 170 to wireless carrier 180. In the exemplary embodiment, wireless carrier 180 is the service provider operating the wireless devices experiencing the fault, such as DUT 122. By connecting to wireless carrier 180 via carrier network 170, diagnostic system 110 can evaluate network level faults in the system.

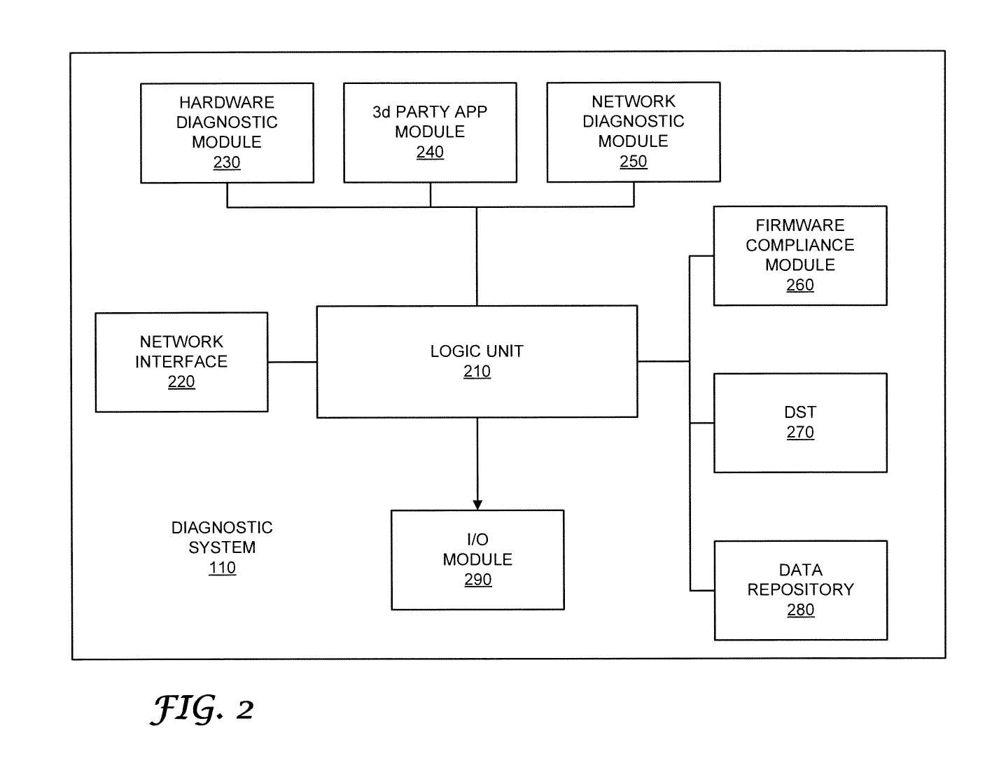

FIG. 2 is a block diagram of diagnostic system 110. Central to diagnostic system 110 is logic unit 210. The block diagram disclosure of FIG. 2 is a functional block diagram. Each of the blocks represents a functional designation, and may represent a hardware-only solution, a software-only solution, or a hardware/software combined solution. Logic unit 210 includes the key functionality for providing a wireless device expert system. Logic unit 210 may be a computing device, such as a mainframe, PC, or application-specific or single-purpose computer. Functionally, logic unit 210 connects to other modules. Network interface 220 provides a functional interface to network 160. Input/output module 290 provides a local input/output capability, so that local users scan access and operate logic unit 210. Logic unit 210 also connects to a plurality of diagnostic modules, which provide the necessary functionality for identifying problems and recommending corrective action. For example, logic unit 210 in the exemplary embodiment. For example, in the exemplary embodiment, logic unit 210 connects to a hardware diagnostic module 230, third-party application module 240, network diagnostic module 250, firmware compliance module 260, data repository 280, and decision science team 270. Note that the foregoing diagnostic modules are disclosed by way of example only, and a diagnostic system 110 may be operated with only a subset of the disclosed modules, or with other modules that provide similar diagnostic capabilities.

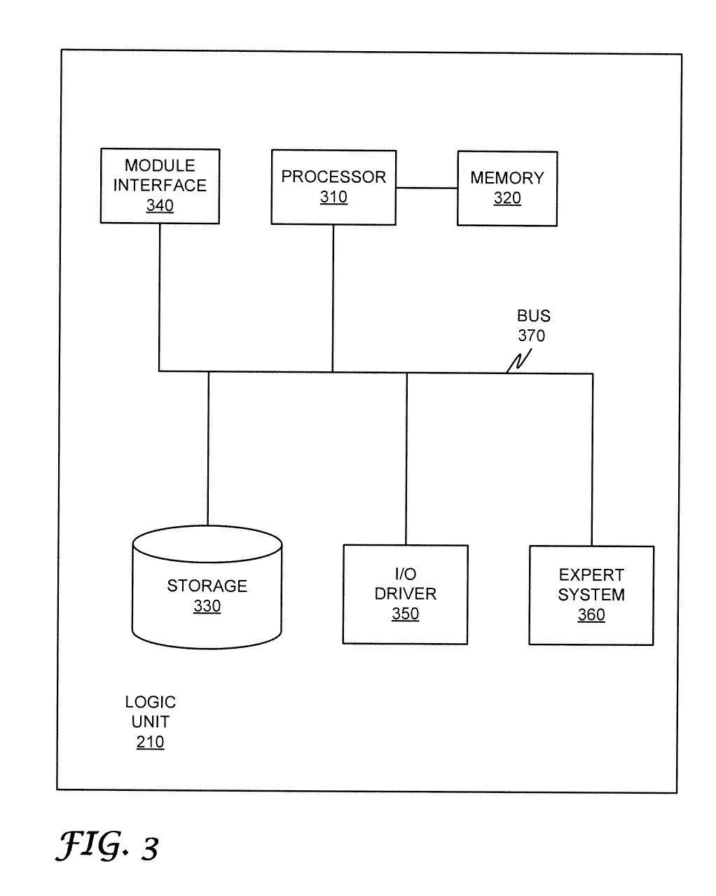

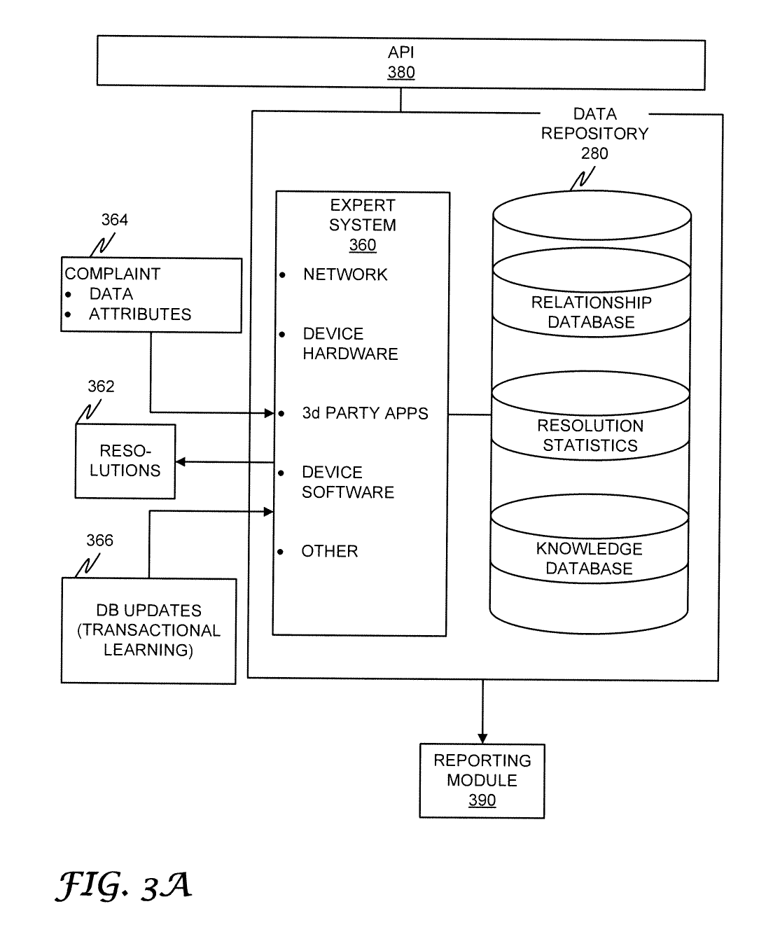

FIG. 3 is a block diagram of logic unit 210. In the exemplary embodiment, logic unit 210 is controlled by a processor 310. Processor 310 may be a central processing unit, digital signal processor, application-specific integrated circuit, or other similar programmable logic device. Processor 310 is connected to a memory 320, which may be random access memory, or other similar low-latency volatile storage medium. In the disclosed embodiments, memory 320 is connected directly to processor 310, providing direct memory access. Other configurations may also be possible. In the disclosed embodiment, processor 310 connects to other system complements via bus 370. For example, processor 310 connects to storage 330. Storage 330 may be a hard disk drive, or other similar relatively high-latency, nonvolatile storage medium. In the exemplary embodiment, storage 330 and memory 320 are separate physical devices. But in some embodiments, the functions of memory 320 and storage 330 may be provided by a single physical device, such as a flash memory, or other memory technology suitable for both data storage and operational memory. Processor 310 also connects to an input/output driver 350. Input/output driver 350 is provided to permit processor 310 to receive commands and instructions, and to report results of its functions, such as to a video display, printer, audio output, or other suitable output technology. Processor 310 also connects to module interface 340. Module interface 340 is provided as a functional designation for an interface configured to permit logic unit 210 to communicate with diagnostic modules, such as those disclosed in FIG. 2. In some embodiments, module interface 340 may be a network interface that connects logic unit 210 to diagnostic modules. In other embodiments, module interface 340 may be a local interface, that provide the diagnostic functionality. In yet other embodiments, module interface 340 may be an interface with a third-party application running on logic unit 210. In yet other embodiments, various combinations of the foregoing example exemplary module interfaces, along with other potential module interfaces may be confined to any single embodiment. Module interface 340 permits processor 310 to communicate with diagnostic modules and receive the necessary data therefrom.

FIG. 3A provides a block diagram disclosing functional aspects of expert system 360. Expert system 360 may be a hardware module, software module, third-party application, or combination of the foregoing providing the necessary expert system functions. According to the exemplary embodiment, expert system 360 receives necessary data from a plurality of diagnostic modules. Expert system 360 is also configured to receive from a user a complaint, which comprises data and attributes. The data and attributes are used to define the type of complaint and the specific parameters of this instance of the complaint. Expert system 360, upon receiving the complaint and the necessary data from the diagnostic modules will consult data repository 280. Data repository 280 includes a relationship database, a resolution statistics database, and a knowledge database. Data repository 280 may also include other suitable databases. The relationship database may be consulted to correlate the complaint, including data and attributes, with known causes. Once the complaint has been classified, expert system 360 may communicate in real time with a user to recommend further actions that will permit expert system 360 to further refine the nature of the problem. Once the nature of the complaint has been isolated to a specific cause was in a suitable degree of confidence, expert system 360 provides the user with a recommended corrective action, or resolution 362. Complaint 364 includes data and attributes. Expert system 360 consults resolution statistics, to isolate the complaint 364 within a suitable degree of confidence. After the user has taken a corrective action, the user may provide feedback to expert system 360, whereby expert system 360 may receive transactional learning data 366, by which it updates data repository 280. These data may be integrated into resolution statistics, thereby providing additional statistical correlation, and may also be used to update the knowledge database, by which additional correlations are identified in the system. In the exemplary embodiment, expert system 360 is a software module, that communicates with other systems of logic unit 210 via API 380. Expert system 360 may also be communicatively coupled with a reporting module 390. Reporting module 390 may provide reports and statistics useful, for example, for trending or actuarial data.

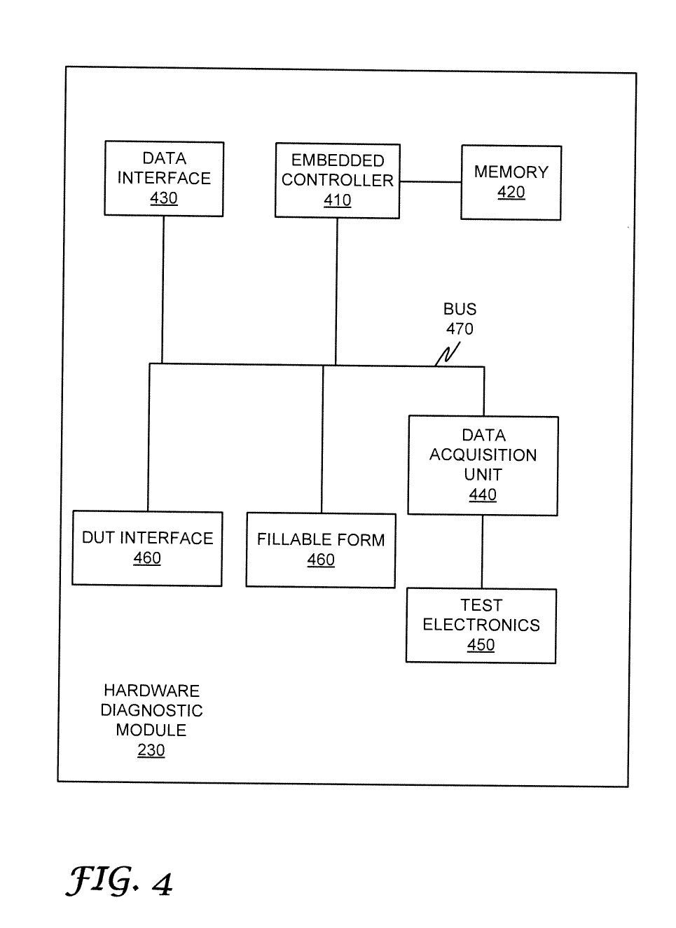

FIG. 4 provides an exemplary embodiment of a hardware diagnostic module 230. Hardware diagnostic module 230 may be controlled by an embedded controller, connected to a memory 420. Embedded controller 410 may be a species of processor, such as processor 310 of FIG. 3, and memory 420 may be a species of memory and/or storage such as those disclosed in FIG. 3. Throughout this specification, memories and embedded controllers should be understood to encompass Those definitions. Hardware diagnostic module 230 is disclosed in the exemplary embodiment as a separate dedicated hardware device, with its own functional software. In other embodiments, hardware diagnostic module 230 may be a software module residing in memory 320 of FIG. 3, or may encompass functional designations provided in more than one physical device and/or location. Throughout this specification, diagnostic modules will be described, by way of example, as computing devices with embedded functionality running in memory. But any of the diagnostic modules disclosed as dedicated hardware systems may also be embodied as a hardware-specific solution, in a software-specific solution, or a functional designation whose components exist in more than one physical location or device.

In the exemplary embodiment, hardware diagnostic module 230 is controlled by an embedded controller 410 communicatively coupled to a memory 420. Embedded controller 410 connects to other components via bus 470. Specifically, embedded controller 410 may connect with module interface 430, which permits hardware diagnostic module 230 to communicate with logic unit 210. Embedded controller 410 also communicatively couples to a DUT interface 460. DUT interface 440 allows DUT 122 to be physically tethered to hardware diagnostic module 230. This may allow hardware diagnostic module 230 to send control signals and receive data that perform testing functions. Embedded controller 410 may also be connected to a data acquisition unit 440, which may permit hardware diagnostic module 230 to connect to test electronics 450. In some embodiments, data acquisition unit 440 and test electronics 450 may be provided instead of DUT interface 460. For example test electronics 450 may be configured to electronically couple to DUT 122, and run hardware diagnostics on DUT 122, and thereby provide data or signals back to embedded controller 470. Finally, embedded controller 410 may receive data via a user interface form 480. In some cases, user interface form 480 will instruct a user to perform a series of functions on DUT 122, and receive the results of those actions via UI form 480. Furthermore, some DUTs 122 may be provided with self test capabilities, which provide results in the form of error codes or other diagnostic information. UI form 480 may permit the user to input the results of such self test functions, so that embedded controller 410 can receive them. Upon receiving the necessary inputs, hardware diagnostic module 230 provides a hardware diagnosis to logic unit 210.

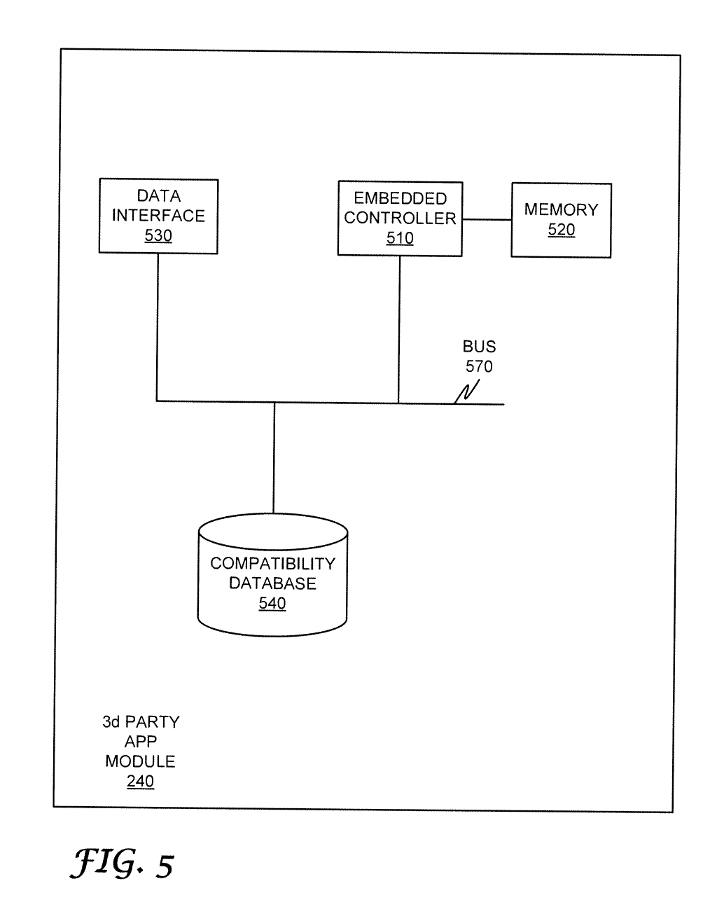

FIG. 5 is a block diagram of an exemplary embodiment of a third-party application module 240. In the exemplary embodiment, third-party application module 240 is controlled by an embedded controller 510 connected to a memory 520, containing diagnostic software. Embedded controller 510 connects via a bus 570 to a module interface 530, which provides communication with logic unit 210. Embedded controller 510 also has access to the compatibility database 540, which contains compatibility data regarding third-party applications, as well as a known issues caused by third-party applications. Compatibility database 540 also may be able to determine whether there are third-party applications installed that conflict with one another. In that case, one recommendation may be to remove or reconfigure at least one of the conflicting applications.

Third-party application module 240 may receive from logic unit 210 a list of third-party applications running on DUT 122, along with a list of hardware characteristics, operating system version, and other key operating data. Third-party application module 240 will check the compatibility database 540 to determine if there are any known interactions or issues with the particular combination of hardware and software.

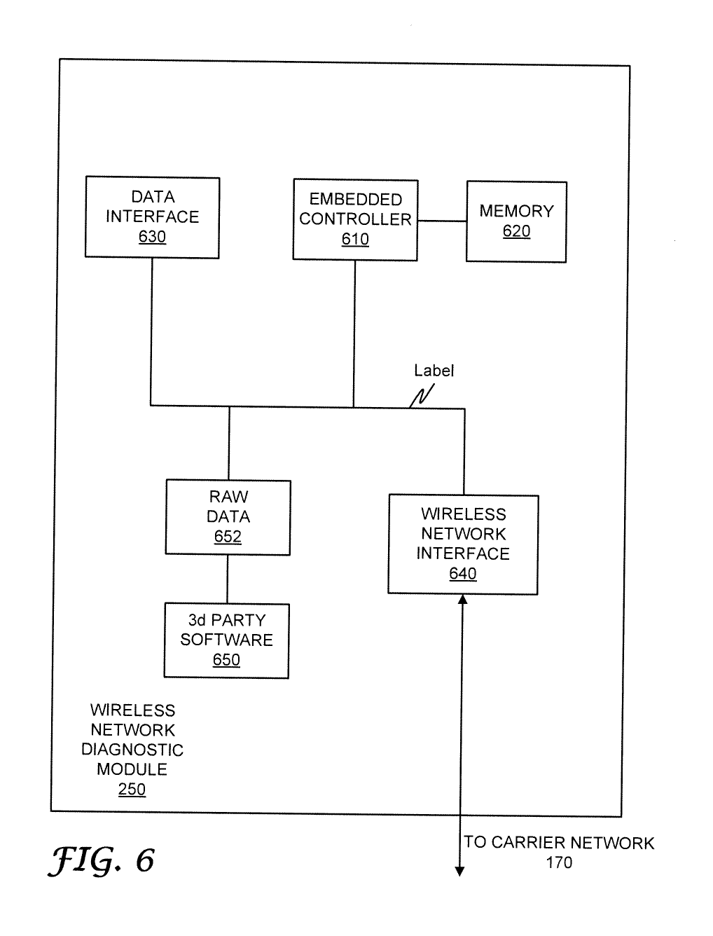

FIG. 6 is a block diagram of an exemplary embodiment of a wireless network diagnostic module 250. In the exemplary embodiment, wireless network diagnostic module 250 is controlled by an embedded controller 610, connected to a memory 620, having stored therein necessary program data. Embedded controller 610 communicates with other complements via bus 670, including module interface 630. Memory 620 may also include diagnostic software, which instructs embedded controller 610 to connect to wireless carrier network 170 via a wireless network interface 640. The diagnostic software may include a battery of tests to be performed to identify network outages and difficulties, to identify common problems such as a down radio tower, or to perform other diagnostic tests that can be performed by testing connectivity via carrier network 170. Alternatively, or in addition, third-party software 650 may also be stored on wireless network module 250, or on DUT 122, and may provide raw data 652 to wireless network diagnostic module 250. The raw data may be analyzed to identify difficulties or problems with the wireless network. Upon performing its designated function, wireless network diagnostic module 250 provides a wireless network diagnostic report to logic unit 210.

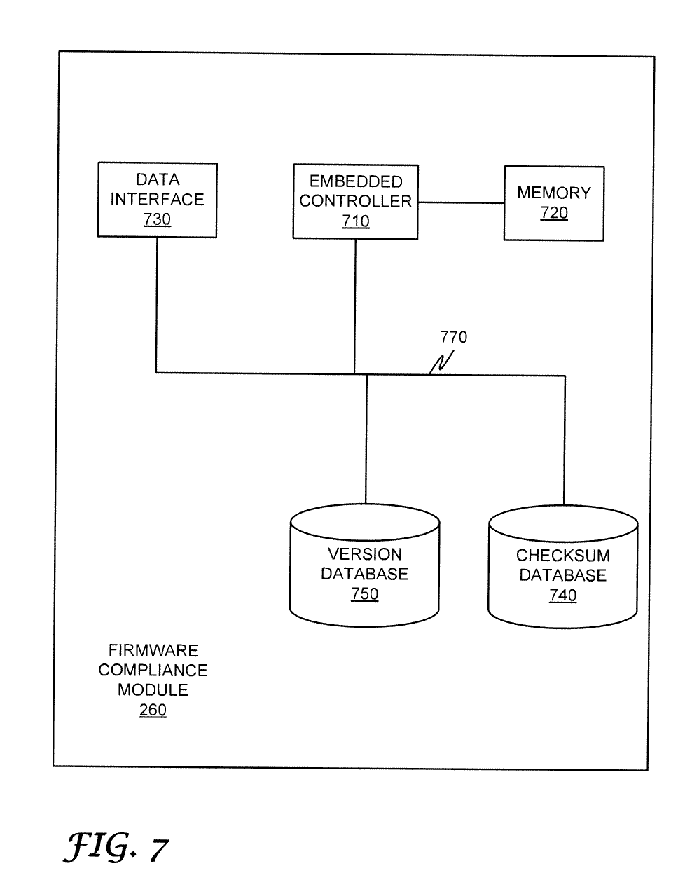

FIG. 7 is an exemplary embodiment of a firmware compliance module 260. In the exemplary embodiment, firmware compliance module 260 is controlled by an embedded controller 710, connected to a memory 720, containing the necessary software modules. Embedded controller 710 connects to other system complements via bus 770. Module interface 730 is configured to connect firmware compliance module 260 to logic unit 210. Firmware compliance module 260 may also include a version database 750, which may contain an up-to-date list of the most current or best firmware versions for each device. Firmware compliance module 260 may then compare the firmware version reported on DUT 122 to version database 750, and determine whether DUT 122 needs an updated firmware, or whether or there is software, such as third-party software installed on DUT 122 that is incompatible with the reported firmware version. Firmware compliance module 260 may also include a checksum database, containing checksums of known good firmware versions. Included in the data reported from DUT 122 may be a checksum of the firmware. By comparing the reported firmware checksum to the checksum database 740, firmware compliance module 260 may be able to determine whether the firmware has become corrupted. After performing its diagnostic functions, firmware compliance module 260 reports its diagnoses to logic unit 210.

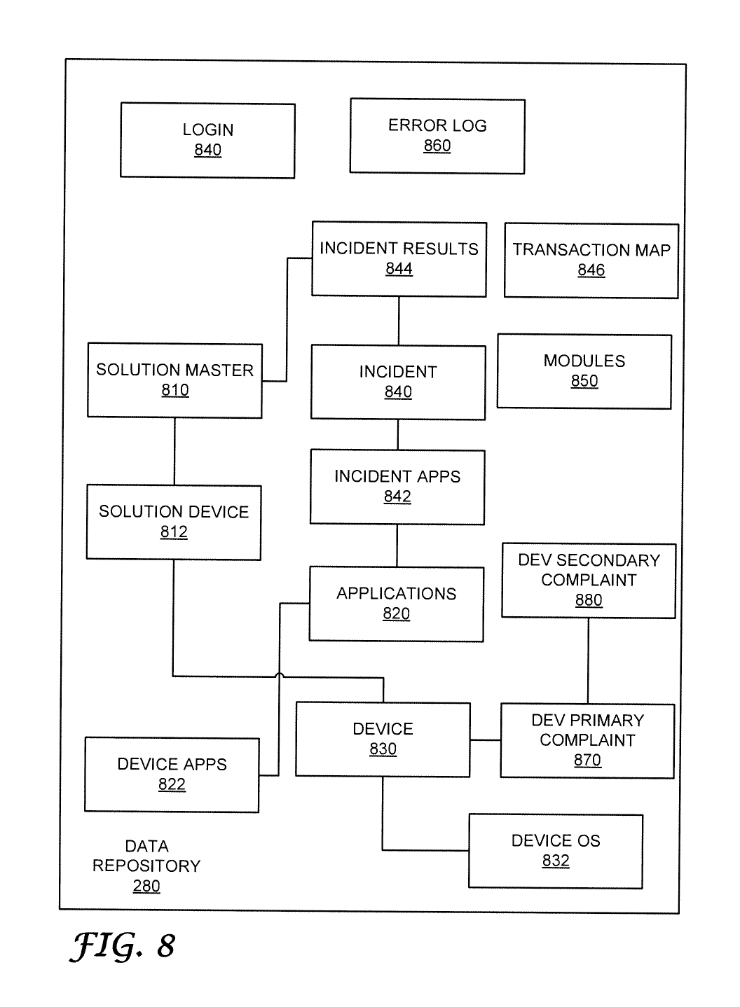

FIG. 8 is a block diagram of data structures of an exemplary data repository, with interconnections between tables as shown. The following table describes the purpose of each data table.

TABLE 4
Data Tables

| Number | Name | Description |
|---|---|---|
| 810 | Solution Master | This table stores the master solutions |
| 812 | Solution Device | This table stores the solutions based on device per primary |
| | | complaint, secondary complaint and device applications (if |
| | | applicable). |
| 820 | Applications | This is the master application table |
| 822 | Device Apps | This table stores the applications that are identified for a given |
| | | device. |
| 830 | Device | This is the master device table |
| 832 | Device OS | This stores the device operating systems for a given device. |
| 840 | Login | This stores the login credentials of the users for the expet |
| | | system. |
| 842 | Incident Apps | This table stores the applications identified on a device in a |
| | | particular incident. |
| 844 | Incident Results | This table stores the results of the incident resolution. |
| 846 | Transaction | This table is used to log the request details of the Web Service |
| | Incident Map | API. When a Web Service API call is made from a external |
| | | system they are required to pass a Request ID which is then |
| | | tied to the incident that the expert system initiates. |
| 850 | Modules | This is the master table of the various diagnostic modules that |
| | | the expert system supports. |
| 860 | Error Log | This table is used to log errors. |
| 870 | Device Primary | This table stores the primary complaints for a given device. |
| | Complaint | |
| 880 | Device Secondary | This table stores the secondary complaints. Every secondary |
| | Complaint | complaint is tied to a primary complaint for a given device. |

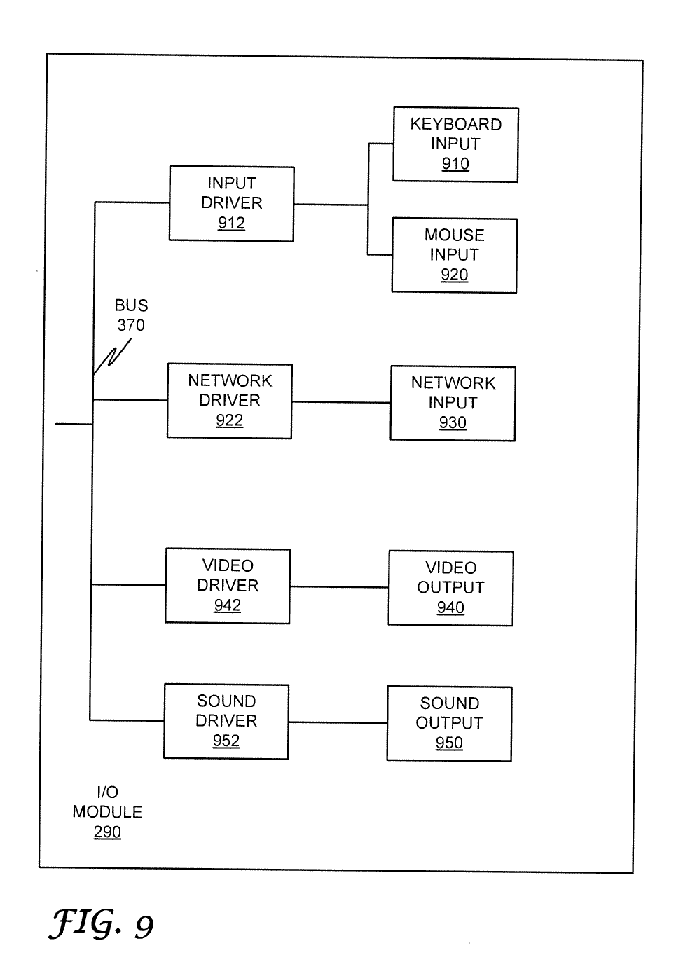

FIG. 9 is a block diagram of an input output module 290 for use with for use with logic unit 210. Input output module 290 may include an input driver 912, network driver 922, video driver 942, and sound driver 952. The foregoing drivers are provided by way of example only, and those having skill in the art may recognize that other or additional drivers may be provided. Input driver 912 may receive input from keyboard input 910 and mouse input and 920. Network driver 922 may provide bidirectional communication with network 160. Video driver 942 may provide video to video output 940. Sound driver 952 may provide sound to sound output 952. Each of the drivers may be connected to logic unit 210 via bus 370.

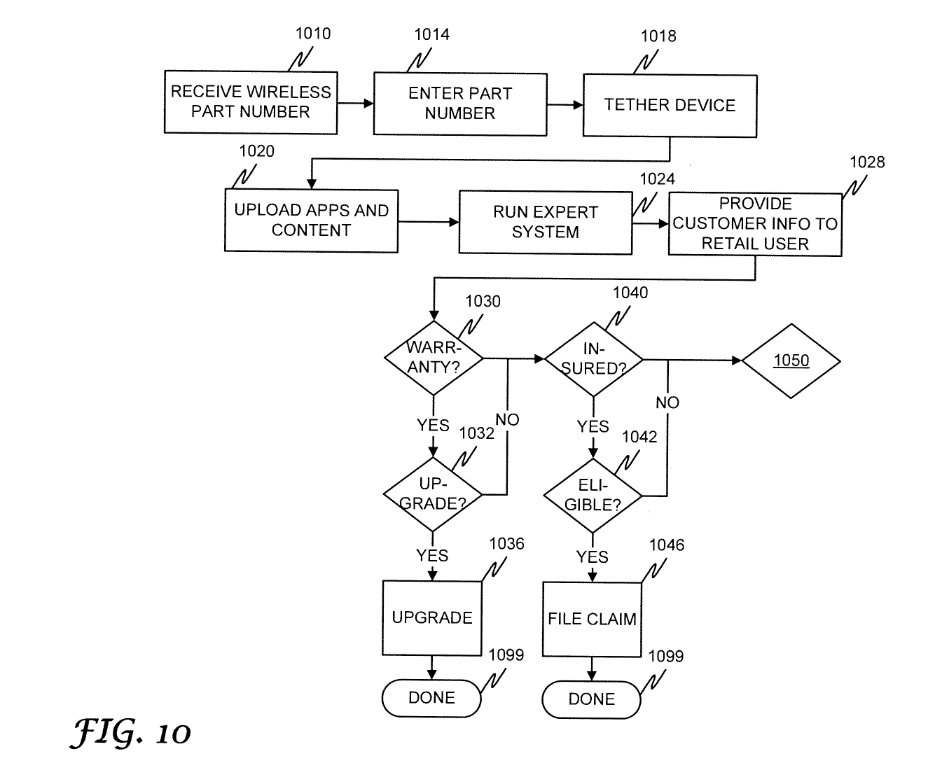

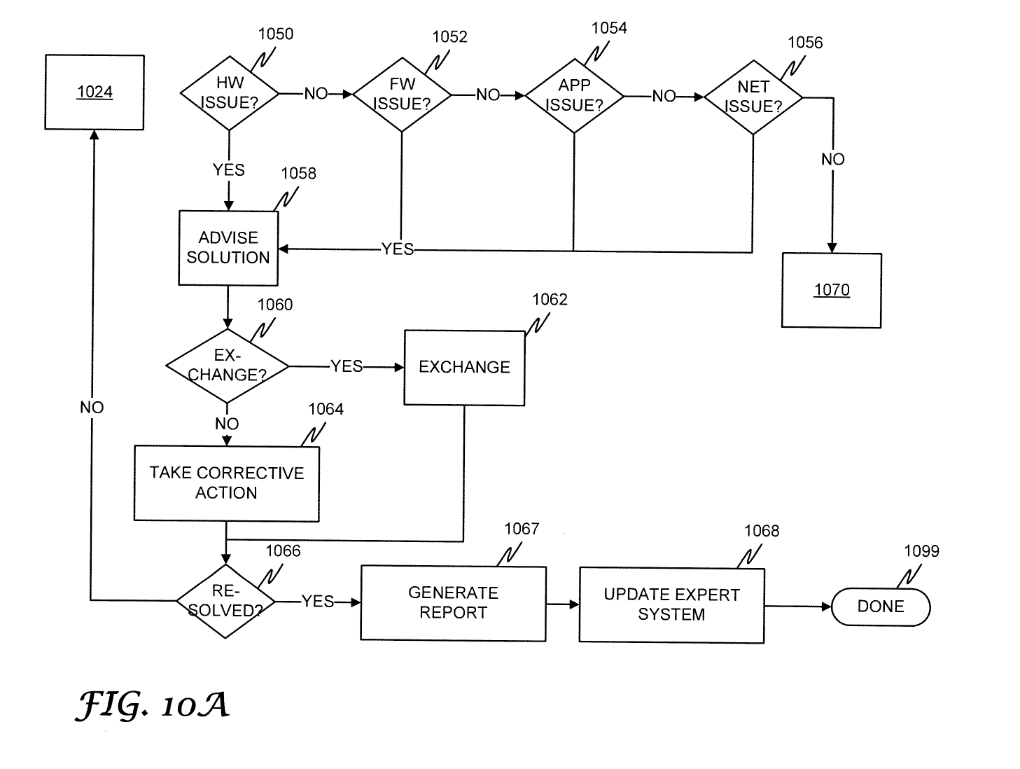

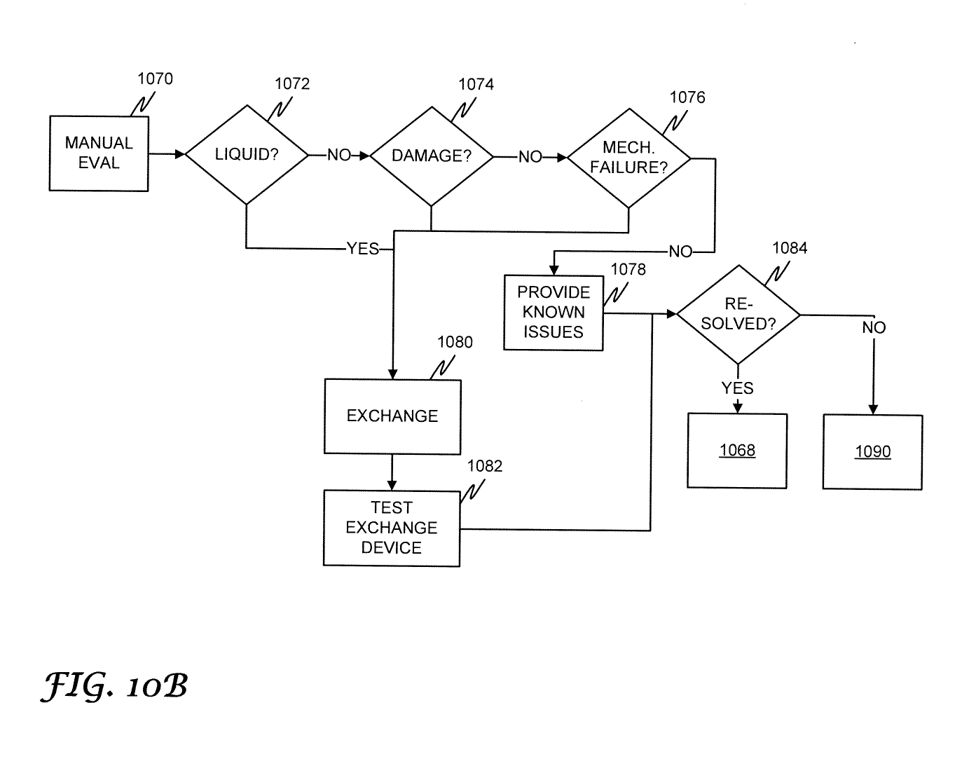

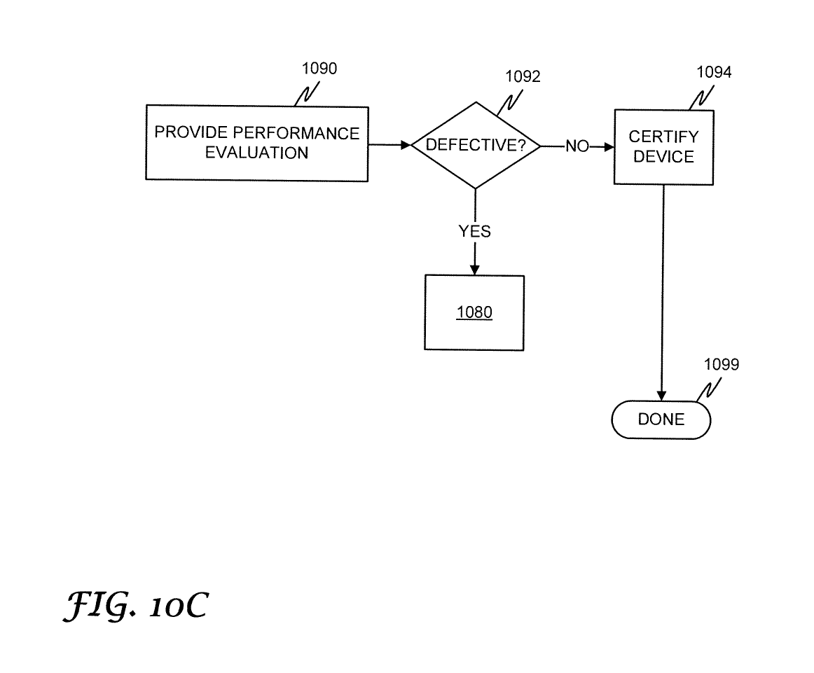

FIGS. 10-10C provide a flowchart of using a wireless device expert system to evaluate a problem with a wireless device. The flowchart may for example, provide a method usable by a retail user 130, receiving DUT 122-2 from a retail customer who has a problem with DUT 122-2. According to the exemplary process, in block 1010 retail user 130 receives the wireless part number from DUT 122-2. The wireless part number may, for example, be printed somewhere in a visible location on DUT 122-2. In block 1014, retail user 130 enters the part number into a form such as input form 142. In block 1018, retail user 130 may tether DUT 122-2 to a module, such as hardware diagnostic module 230, including DUT interface 460. In block 1020, retail user 130 uploads third-party applications and content to diagnostic system 110. In block 1024, diagnostic system 110 runs the expert system. In block 1028, diagnostic system 110 provides customer info information back to retail user 130. In block 1030, retail user 130 checks to see whether DUT 122-2 is under warranty. If DUT 122-2 is under warranty, then in block 1032, a decision is made whether to upgrade. The decision is based on both whether the customer is eligible for an upgrade, and whether the customer desires to upgrade. If in block 1032 the customer decides to upgrade, then in 1036 DUT 122-2 is upgraded to a new device, and in block 1099 the transaction is finished. If in block 1030 the device is not under warranty, or if in 1032 the user decides not to upgrade, then block 1040 is a query of whether the DUT 122-2 is insured. If the device is insured, then in block 1042, there is a check to see whether the user is eligible for an insurance claim. If the user is eligible, then in block 1046 the user files the claim and the transaction is finished. If in block 1040 the device is not insured, or in block 1042 the user is not eligible for the insurance claim, then the expert system proceeds to block 1050, shown on FIG. 10A.

Block 1050 is a query of whether the expert system has identified a hardware issue. Block 1052 is a query of whether the expert system has identified a firmware issue. Block 1054 is a query to determine whether or the expert system has identified a third-party application issue. Block 1056 is a query of whether the expert system has identified a network issue. If any one of these issues is identified, then in block 1058 the expert system advises a potential solution. In block 1060, if the solution involves an exchange, then the device is exchanged in block 1062. If the advised solution does not include an exchange according to block 1060, then in block 1064 the retail user 130 is advised to take corrective action. Block 1066 is a query to determine whether or the advised solution of 1058 has resolved the issue. If the issue is resolved, then in block 1067 a report is generated, and in block 1068 the expert system is updated with the successful resolution, thereby updating success statistics, and the process is finished. If in block 1066 the issue is not resolved, then the process returns to block 1024 for further action by the expert system. If none of the issues of blocks 1050, 1052, 1054, and 1056 identify an issue, then the process proceeds to block 1070, shown on FIG. 10B. In block 1070, decision science team 270 provides a manual valuation of the device. Block 1072 is a query for whether there is a liquid intrusion on the device, commonly indicated by, for example, a moisture sensitive sticker that changes color upon a liquid intrusion. Block 1074 is a query of whether there is physical damage to the device. Block 1076 is a query of whether or there is a mechanical failure. If any of the blocks of 1072, 1074, or 1076 are present, then the process proceeds to an exchange in block 1080. In block 1082 the exchange device is tested. If none of the problems of blocks 1072, 1074, or 1076 are identified, then in block 1078, the expert system provides retail user 130 with a list of known issues for the device. According to block 1084, if any of the foregoing steps to resolve the issue, then the process proceeds to block 1068 of the FIG. 1080. If the issue is not resolved, then the process proceeds to block 1090 of FIG. 10C.

According to block 1090, there is a performance of valuation of the device by DST 270. If the DST 270 determines that DUT 122-2 is defective, in block 1092, then the process proceeds to block 1080 of FIG. 10B. If the device is not defective, then according to block 1094, DST 270 may certify the device. Certifying the device may include providing a certificate to retail user 130, and/or the customer, indicating that the device has been found to be fully functional. This may, for example, permit DUT 122-2 to be provided with warranty coverage. After the device is certified according to block 1094, the process completes.

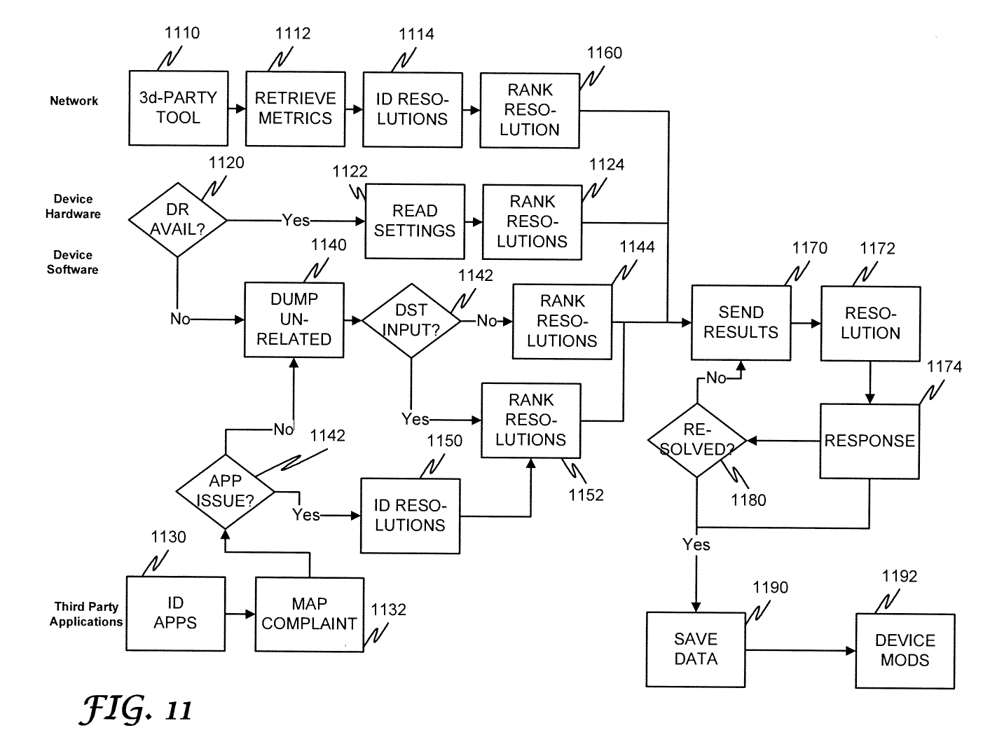

FIG. 11 is a block diagram more particularly disclosing a method used by a expert system 360 to perform diagnostics according to a plurality of diagnostic modules. In particular, a network diagnostic module, a hardware diagnostic module, a software diagnostic module, and a third-party application module are disclosed in FIG. 11. In block 1110, a third-party application performs a network diagnosis and sends data to network diagnostic module 250. The network diagnostic module 250 receives device performance metrics related to the network, and then identifies potential resolutions for the identified metrics in block 1114. In block 1160, the module ranks the resolutions, and then in block 1170 sends the results to the expert system. In block 1120, there is a query of whether a device reader is available. If there is a device reader available, capable of interfacing with DUT 122, then in block 1122, the device reader reads settings from DUT 122. In block 1124 potential resolutions related to those settings are ranked. If no device reader is available in 1120, then in block 1140 non-related resolutions are identified using the sub complaint and resolution attributes. Those nonrelated resolutions are discarded. In block 1142, there is a query of whether DST 270 has provided weightings for the resolutions. If the DST 270 has provided resolution weights, then in block 1152 the resolutions are ranked according to those weights, and if there is no DST input, then in 1144 the resolutions are ranked without DST input.

In block 1170, the hardware diagnostic module sends results to the expert system. Block 1130 provides a process for third-party application module. In block 1130, third-party applications are identified. In block 1132, the module determines if the sub complaint maps to any third party applications on the device. If the complaint maps to a known third-party issue, then in block 1142, control passes to block 1150 where resolutions are identified, and in block 1152 the resolutions are ranked. If there are no known application issues, in block 1142, then the process passes to block 1140 and continues. Once the modules have each sent the results according to blocks 1170, then in block 1172, the expert system provides recommended resolutions. In block 1174 the expert system receives a response in the form of feedback from the user. The feedback may include, for example, whether the issue has been resolved. In block 1180, if the issue has not been resolved, then in block 1170 the next most relevant resolution on the list is provided and the process continues. In block 1180, if the issue is resolved, then in block 1180 the data are provided to DST 270 for integration into future decisions. Finally, in block 1192, the expert system, including data repository 280, is updated with the results of the successful resolution.

While the subject of this specification has been described in connection with one or more exemplary embodiments, it is not intended to limit the claims to the particular forms set forth. On the contrary, the appended claims are intended to cover such alternatives, modifications and equivalents as may be included within their spirit and scope.

What is claimed is:

1. A diagnostic system for diagnosing faults in a wireless device, the diagnostic system comprising:
a processor;
a module interface communicatively coupled to the processor and configured to communicatively couple the processor to a plurality of diagnostic modules;
an input/output module communicatively coupled to the processor and configured to communicatively couple the processor to a user testing the wireless device;
a tangible storage medium having stored thereon a data repository, the data repository configured to correlate wireless device faults with probable causes;
the tangible storage medium further having stored thereon software instructions executable by the processor that, when executed, are configured to instruct the processor to:
receive a complaint from the user, the complaint comprising data and attributes;
compare the complaint data and complaint attributes respectively to records of the data repository, and based on the comparison, select one or more diagnostic modules to query for a proposed resolution;
provide at least one of the complaint data or complaint attributes to the selected module or modules over the module interface;
receive from the module, over the module interface, a diagnostic report including at least one proposed resolution;
ranking the proposed resolutions according to probable causation of the complaint; and
providing to the user, over the input/output module, a recommended resolution.

2. The diagnostic system of claim 1 wherein the software instructions further comprise instructions to receive from the user, over the user interface, a report on the result of the recommended resolution, and to update the data repository in response to the report.

3. The diagnostic system of claim 2 wherein the software instructions further comprise instructions to, upon receiving a report of a failed resolution, to iteratively provide the next-most-probable resolution until the report indicates success or the proposed resolutions are exhausted.

4. The diagnostic system of claim 1 wherein the diagnostic modules comprise a hardware diagnostic module, a third-party application module, a network diagnostic module, and a firmware compliance module.

5. The diagnostic system of claim 4 wherein the software instructions are further configured to instruct the processor to receive input from a human decision science team.

6. The diagnostic system of claim 5 wherein the input from the decision science team includes weight values for proposed resolutions.

7. The diagnostic system of claim 1 wherein the diagnostic modules includes at least a hardware diagnostic module configured to analyze the functionality of hardware of the wireless device.

8. The diagnostic system of claim 7 wherein the hardware diagnostic module comprises a user input form designed to collect user-discoverable data about the hardware.

9. The diagnostic system of claim 7 wherein the hardware diagnostic module is configured to tether to the wireless device and perform electronic diagnostics.

10. The diagnostic system of claim 1 wherein the diagnostic modules include at least a third-party application module configured to receive a list of third-party applications installed on the wireless device and compare the list to a master table of third-party applications known to cause errors with wireless devices.

11. The diagnostic system of claim 10 wherein the third-party application module is further configured to detect corrupted third-party applications.

12. The diagnostic system of claim 10 wherein the third-party application module is further configured to receive a plurality of third-party applications and to identify conflicts between third-party applications.

13. The diagnostic system of claim 1 wherein the diagnostic modules include at least a network diagnostic module configured to test network operations with a carrier network.

14. The diagnostic system of claim 13 wherein the network diagnostic module includes a third-party application configured to provide data related to network functionality.

15. The diagnostic system of claim 13 wherein the network diagnostic module is configured to detect a wireless tower outage.

16. The diagnostic system of claim 13 wherein the network diagnostic module is configured to perform wireless communication tests with the carrier network to evaluate the reliability and availability of the carrier network.

17. The diagnostic system of claim 1 wherein the diagnostic modules include at least a firmware compliance module configured to compare the installed firmware to a master list of best firmware versions.

18. A method of diagnosing a fault on a wireless device, performable by an expert system, the method comprising the steps of:
receiving a complaint;
based on the complaint, selecting at least one diagnostic module from a plurality of available diagnostic modules for analysis of the complaint;
providing the complaint to the selected diagnostic modules;
receiving from the selected diagnostic modules at least one recommended resolution;
ranking the recommended resolutions according to probability; and
providing the most probable recommended resolution as a recommended action for correcting the fault.

19. The method of claim 18 wherein selecting at least one diagnostic module includes selecting at least one diagnostic module from the group consisting of a hardware diagnostic module, a third-party application module, a network diagnostic module, and a firmware compliance module.

20. The method of claim 18 further comprising the steps of receiving input from a human decision science team and integrating the input into the ranking step.

21. The method of claim 20 wherein receiving input from the human decision science team includes receiving weighting values for the recommended resolutions.

22. A wireless device expert system for evaluating faults in a wireless device, the expert system comprising:
a logic unit configured to communicatively couple to a plurality of diagnostic modules;
a hardware diagnostic module configured to evaluate hardware functionality of the wireless device;
a third-party application module configured to evaluate third-party applications installed on the wireless device;
a network diagnostic module configured to test connectivity between the wireless device and a carrier network;
a firmware compliance module configured to evaluate the installed firmware on the wireless device;
a data repository including statistical correlations between faults and causes;
wherein the logic unit is configured to:
receive a complaint indicating a fault with the wireless device;
based on the complaint, select at least one diagnostic module to query for potential resolutions;
query the selected diagnostic modules;
receive from the selected diagnostic modules at least one recommended resolution;
rank the recommended resolutions according to probability provided by the data repository; and
provide the first-ranked resolution as the recommended resolution.

23. The expert system of claim 22 wherein the logic unit is further configured to receive a results report indicating the success of the recommended resolution and to update the data repository based on the success of the resolution.

24. The expert system of claim 22 wherein the logic unit is further configured to determine whether the recommended resolution was successful, and upon determining that the recommended resolution was not successful, iteratively provide the next-most-probable recommended resolution until the resolution is determined to be successful or the list of recommended resolutions is exhausted.
